(19) United States
(12) Patent Application Publication
(10) Pub. No.: US 2008/0032786 A1
(43) Pub. Date: Feb. 7, 2008

(54) Gaming machine and gaming machine playing method

(75) Inventor: Norio Hosokawa, Tokyo (JP)

Correspondence Address: ARENT FOX LLP, 1050 CONNECTICUT AVENUE, N.W., SUITE 400, WASHINGTON, DC, 20036, US

(73) Assignee: ARUZE Corp.

(21) Appl. No.: 11/882,404

(22) Filed: Aug. 1, 2007

(30) Foreign Application Priority Data
Aug. 2, 2006 (JP) 2006-211231

(51) Int. Cl. A63F 13/10; A63F 13/00; A63F 9/24; A63F 13/02

(52) U.S. Cl. 463/25; 463/20; 463/26; 463/31; 463/43

(57) ABSTRACT

To provide a gaming machine which can increase an entertainment aspect by changing a disposition of a plurality of symbols and payout lines displayed on a display portion provided in the gaming machine, thus providing a visual change.

Symbol column data, in which an order of a plurality of symbols configured of a plurality of kinds of symbol image is fixed, corresponding one to each of display areas disposed in a three row by three column matrix formation on a lower image display panel of a slot machine, an image of a symbol based on one symbol data, among the corresponding symbol column data, is displayed in each display area. Then, in the event that a prescribed condition is met, a correlation relationship between the display areas, and the symbol column data corresponding one to each of them, is changed.

### RELATED APPLICATION

This application claims the priority of Japanese Patent Application No. 2006-211231 filed on Aug. 2, 2007, which is incorporated herein by reference.

### BACKGROUND OF THE INVENTION

1. Technical Field

The present invention relates to a gaming machine and a gaming machine playing method for carrying out a game using a coin, a bill or the like.

2. Related Art

A slot machine, widely known as one kind of gaming machine, is configured in such a way that one game is started by a game medium such as a coin being inserted, symbol columns, as well as being variably displayed in prescribed positions in the slot machine, are stop displayed after a prescribed time has elapsed, and the game medium is paid out based on a combination of the stopped symbols. Also, as a device which variably displays the symbol columns, there are, broadly categorizing, one based around a mechanical reel, and one based around a video reel. For example, slot machines carrying out a display of a total of fifteen symbols, arranged three by five, using the video reel and the mechanical reel are described in U.S. Pat. No. 6,093,102 and U.S. Pat. No. 6,960,133. In these slot machines, when the game is started, the reel rotates, in conjunction with which symbols of each column disposed in a vertical direction start a variation and, along with a stopping of the reel rotation after the prescribed time has elapsed, three symbols are stop displayed in each column. Then, in the event that the symbols have been stop displayed in a combination in which there exists a quantity of the same kind of symbol equal to or greater than a prescribed quantity, a prize is awarded.

However, in the heretofore known slot machine using the video reel, when carrying out a redisplay of a plurality of symbols, a scroll display has been cyclically carried out, in a display position of each symbol, of a plurality of a plurality of kinds of symbol, in a predetermined order. That is, they have been displayed to the player exactly as though a plurality of mechanical reels were rotating. That is, as the symbol columns (specifically, the display order of each symbol when carrying out the scroll display) have always been constant, not providing the player with any kind of novelty, in the event that the game is played for a long time, there has been a possibility of the player becoming bored.

### SUMMARY OF THE INVENTION

The invention, therefore, has an object of providing a gaming machine which, scroll displaying each of a plurality of symbols displayed in a display portion in a predetermined display position, by interchanging symbol columns, provides a visual change and further increases an entertainment aspect.

In order to achieve the previously described object, a gaming machine (for example, a slot machine 10) according to claim 1 includes: a display (for example, a lower image display panel 14) on which are fixed a plurality of display positions displaying symbol images; a memory (for example, a RAM 43) which, as well as storing a plurality of symbol column data fixing an order of a plurality of symbol data configured of a plurality of kinds of symbol data, stores correlation data indicating a correlation between each of the relevant plurality of symbol column data and each of the plurality of display positions; and a processor (for example, a main CPU 41) which, in accordance with an instruction from the player, referring to the symbol column data and correlation data stored in the memory, after carrying out a scroll display in the display positions of the symbol images based on symbol data configuring the corresponding symbol column data in accordance with the order indicated by the relevant symbol column data, carries out a redisplay of the symbol images by stopping the relevant scroll display and, as well as providing an award to the player in accordance with a combination of the relevant redisplayed symbol images, changes the correlation between the plurality of symbol column data and the plurality of display positions in the correlation data stored in the memory.

Also, in a gaming machine (for example, the slot machine 10) according to claim 2, the processor (for example, the main CPU 41) counts an execution quantity of the game and, every time the counted execution quantity of the game reaches a predetermined quantity, changes the correlation between the plurality of symbol column data and the plurality of display positions in the correlation data stored in the memory (for example, the RAM 43).

Also, in a gaming machine (for example, the slot machine 10) according to claim 3, the processor (for example, the main CPU 41), in the event that the combination of redisplayed symbols is a predetermined combination, changes the correlation between the plurality of symbol column data and the plurality of display positions in the correlation data stored in the memory (for example, the RAM 43).

Also, in a gaming machine (for example, the slot machine 10) according to claim 4, the processor (for example, the main CPU 41) counts a quantity of game media inserted by the player in order to start the game, and a quantity of the game media paid to the player as the award and, in the event that a difference between the quantity of game media inserted and the quantity of game media paid out exceeds a predetermined quantity, changes the correlation between the plurality of symbol column data and the plurality of display positions in the correlation data stored in the memory (for example, the RAM 43).

Also, a gaming machine (for example, the slot machine 10) according to claim 5 further including a timer which measures a time, the processor (for example, the main CPU 41), every time the timer measures a predetermined time, changes the correlation between the plurality of symbol column data and the plurality of display positions in the correlation data stored in the memory (for example, the RAM 43).

Also, in a gaming machine (for example, the slot machine 10) according to claim 6, the processor (for example, the main CPU 41), every time the player inserts the game medium in order to start the game, changes the correlation between the plurality of symbol column data and the plurality of display positions in the correlation data stored in the memory.

Also, a playing method of the gaming machine (for example, the slot machine 10) according to claim 7 includes: displaying some symbol images, from among a plurality of symbol columns, corresponding to each of a plurality of display positions fixed on a display, each configured of a plurality of symbol images composed of a plurality of kinds of symbol image, in which an order of the relevant plurality of symbol images is fixed, in the corresponding display positions; in accordance with an instruction from the player, after scroll displaying the relevant symbol columns corresponding to each of the plurality of display positions, carrying out a redisplay of the symbol image by stopping the relevant scroll display; providing an award to the player in accordance with a combination of the relevant redisplayed symbol images; and changing the correlation between the plurality of symbol columns and the plurality of display positions.

Also, a playing method of the gaming machine (for example, the slot machine 10) according to claim 8 further includes: counting an execution quantity of the game; and every time the counted execution quantity of the game reaches a predetermined quantity, changing the correlation between the plurality of display positions and the plurality of symbol columns.

Also, a playing method of the gaming machine (for example, the slot machine 10) according to claim 9 further includes: in the event that the combination of redisplayed symbols is a predetermined combination, changing the correlation between the plurality of display positions and the plurality of symbol columns.

Also, a playing method of the gaming machine (for example, the slot machine 10) according to claim 10 further includes: counting a quantity of game media inserted by the player in order to start the game, and a quantity of the game media paid to the player as the award; and in the event that a difference between the quantity of game media inserted and the quantity of game media paid out exceeds a predetermined quantity, changing the correlation between the plurality of display positions and the plurality of symbol columns.

Also, a playing method of the gaming machine (for example, the slot machine 10) according to claim 11 further includes: changing the correlation between the plurality of display positions and the plurality of symbol columns on every measuring of a predetermined time.

Also, a playing method of the gaming machine (for example, the slot machine 10) according to claim 12 further includes: changing the correlation between the plurality of display positions and the plurality of symbol columns every time the player inserts the game medium in order to start the game.

According to the gaming machine of the invention, symbol columns each configured of a plurality of symbols, scroll displayed in a certain order one in each of a plurality of display positions fixed in advance on a display, are interchanged among the plurality of display positions. For this reason, it is possible to provide a player with a freshness unobtainable with the heretofore known gaming machines, and prevent the player from becoming easily bored. Also, as a possibility of a combination of symbols which results in a dividend being paid out being redisplayed changes depending on details of symbols configuring the interchanged symbol columns, it is possible to attract an interest of the player in a game.

Herein, it is also acceptable to arrange in such a way that the symbol columns are interchanged among the plurality of display positions every time a prescribed number of games is carried out. By this means, for example, even when a payout of a high dividend does not occur while playing the game for a long time, and the player is playing the game aimlessly, by adding to the game, for the player, an extra feature of interchanging the symbol columns, it is possible to prevent the player from becoming easily bored.

Also, it is also acceptable to arrange in such a way that the symbol columns are interchanged among the plurality of display positions when a combination of redisplayed symbols is a predetermined combination. By this means, the combination of redisplayed symbols does not only have a role of determining whether or not the dividend is paid out, but also has a new role of determining whether or not the symbol columns are interchanged. Therefore, in comparison with the heretofore known gaming machines, there is a possibility of being able to cause the player to have a greater interest in combinations of symbols along payout lines, and being able to prevent the player from becoming easily bored.

Also, it is also acceptable to arrange in such a way that the symbol columns are interchanged among the plurality of display positions when a difference between a quantity of game media inserted in order to start the game and a quantity of game media paid out exceeds a predetermined quantity. By this means, for example, in the event that games in which a dividend is not paid out, or only a small dividend is paid out, continue, it being possible to interchange the symbol columns among the plurality of display positions, there is a possibility of being able to prevent the player's interest in the game from waning.

Also, it is also acceptable to arrange in such a way that the symbol columns are interchanged among the plurality of display positions every time a predetermined time elapses. By this means, by regularly providing the player with a visual freshness, it is possible to prevent him or her from becoming easily bored with the game.

Also, it is also acceptable to arrange in such a way that the symbol columns are interchanged among the plurality of display positions every time one game is carried out. By this means, the player being able, every game, to carry out the game with a fresh feeling, as though he or she is carrying out the game on a different gaming machine, it is possible to prevent the player from becoming easily bored with the game.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

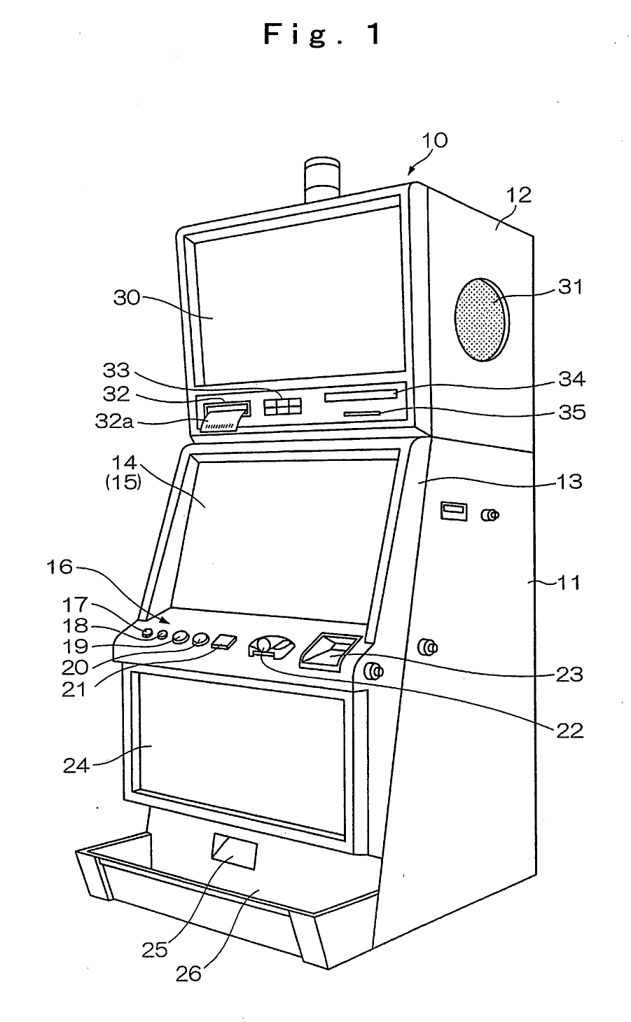

FIG. 1 is a perspective view showing an external appearance of a slot machine as one example of a gaming machine in a first embodiment of the invention;

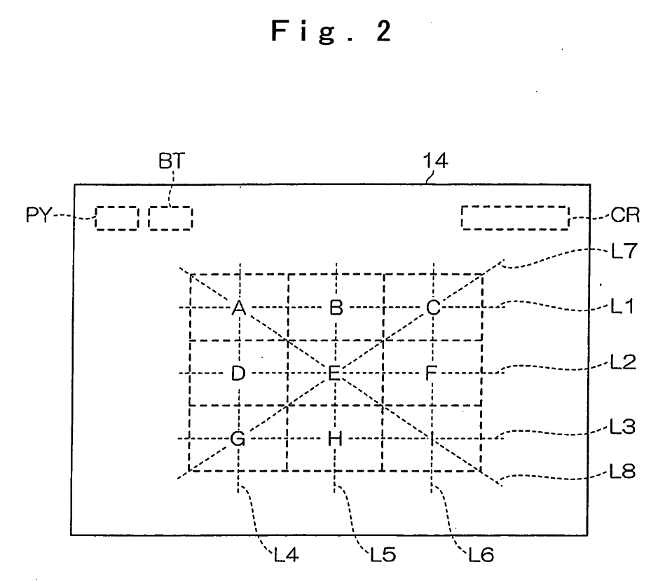

FIG. 2 is an explanatory diagram for describing display details of an image display device included in the gaming machine in the first embodiment of the invention;

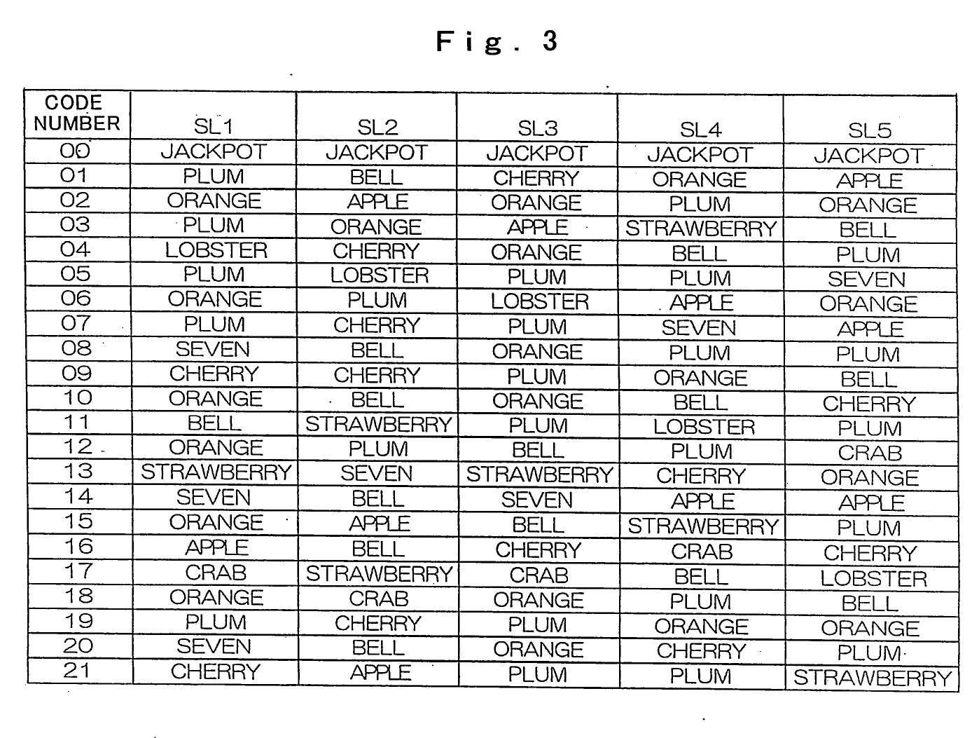

FIG. 3 is an explanatory diagram for describing details of symbol column data referred to when displaying symbols on a screen of the image display device included in the gaming machine in the first embodiment of the invention;

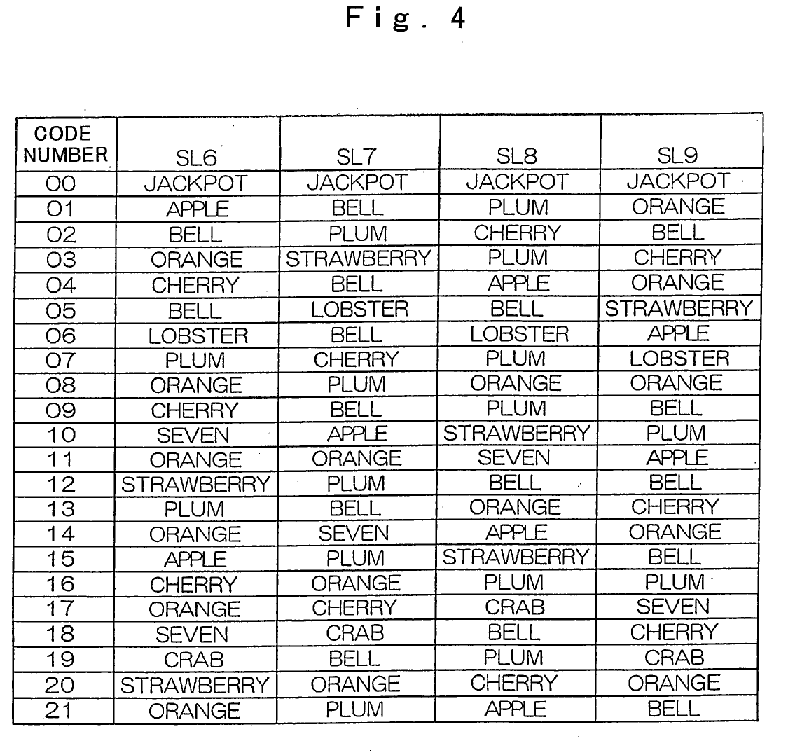

FIG. 4 is an explanatory diagram for describing details of symbol column data referred to when displaying symbols on the screen of the image display device included in the gaming machine in the first embodiment of the invention;

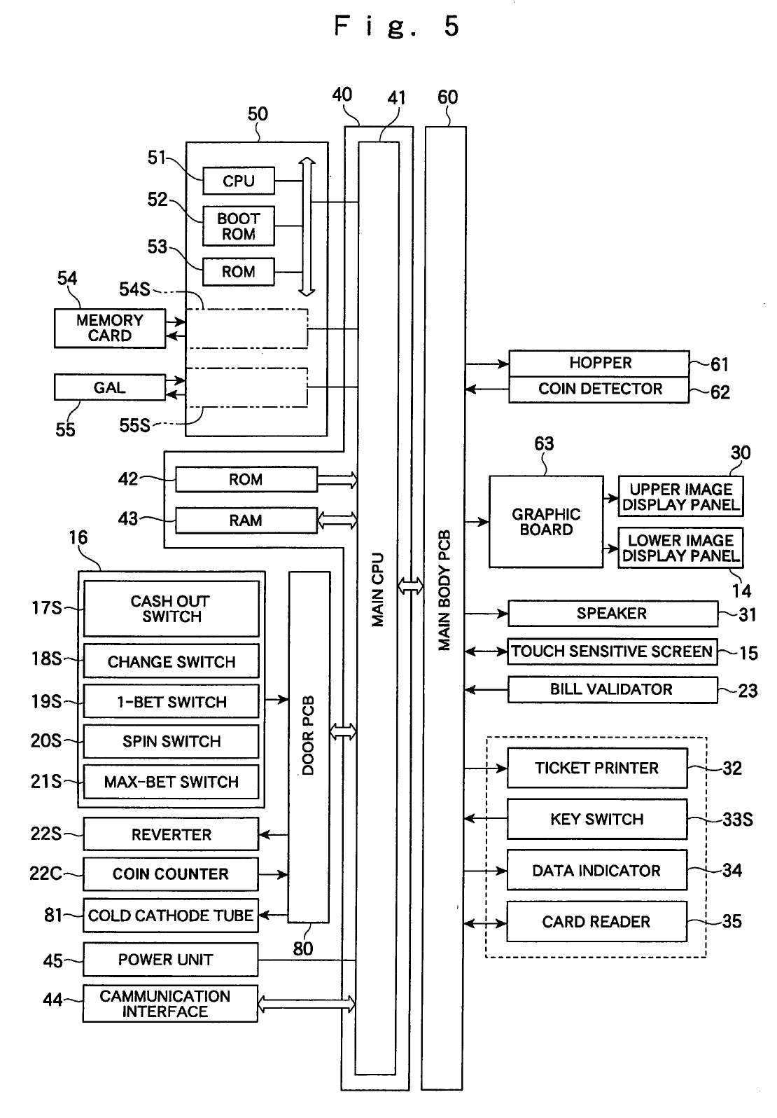

FIG. 5 is a block diagram showing a configuration of a control device included in the gaming machine in the first embodiment of the invention;

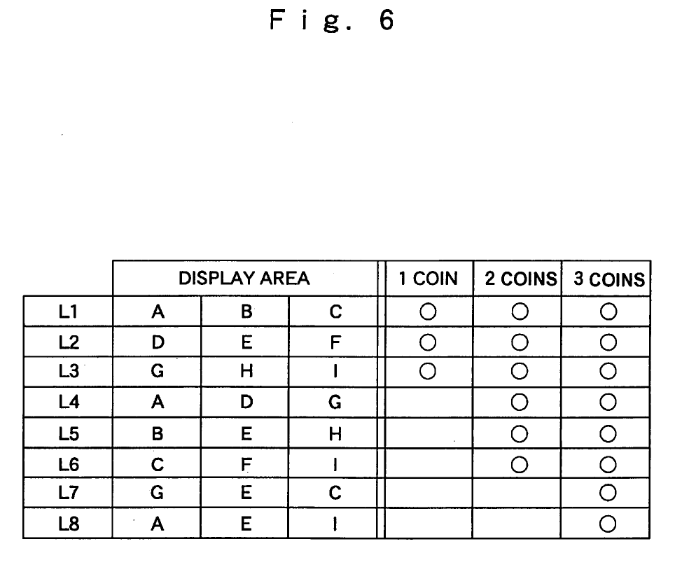

FIG. 6 is an explanatory diagram for describing details of data relating to payout lines, referred to when processing a game program executed by the gaming machine in the first embodiment of the invention;

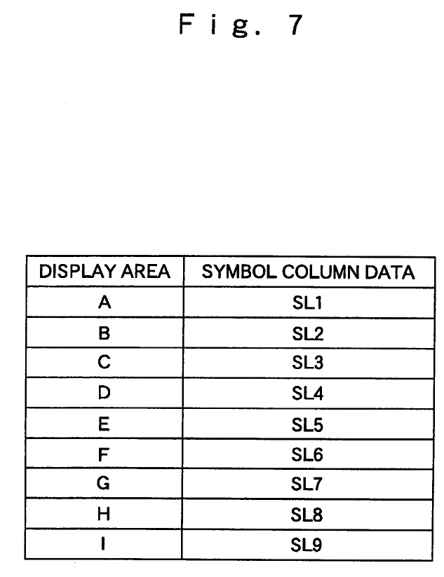

FIG. 7 is an explanatory diagram for describing details of data indicating a correlation between display areas and the symbol column data, referred to when processing the game program executed by the gaming machine in the first embodiment of the invention;

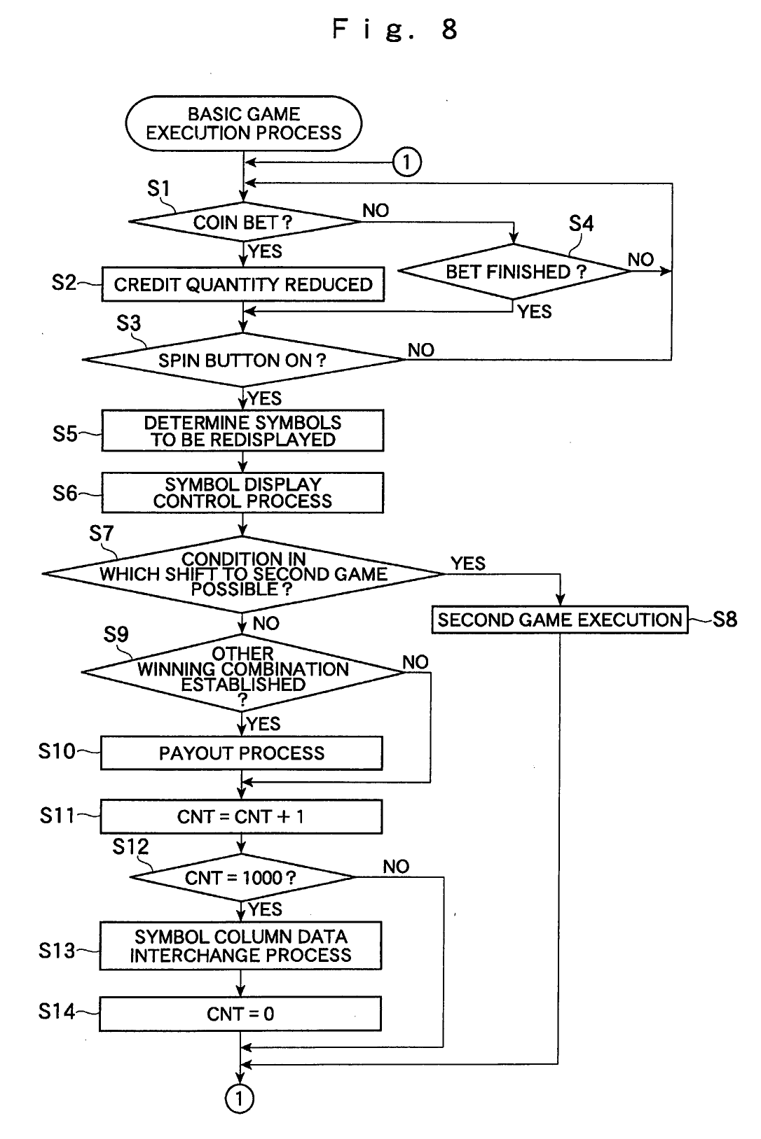

FIG. 8 is a flowchart showing processing details of a basic game program executed by the gaming machine in the first embodiment of the invention;

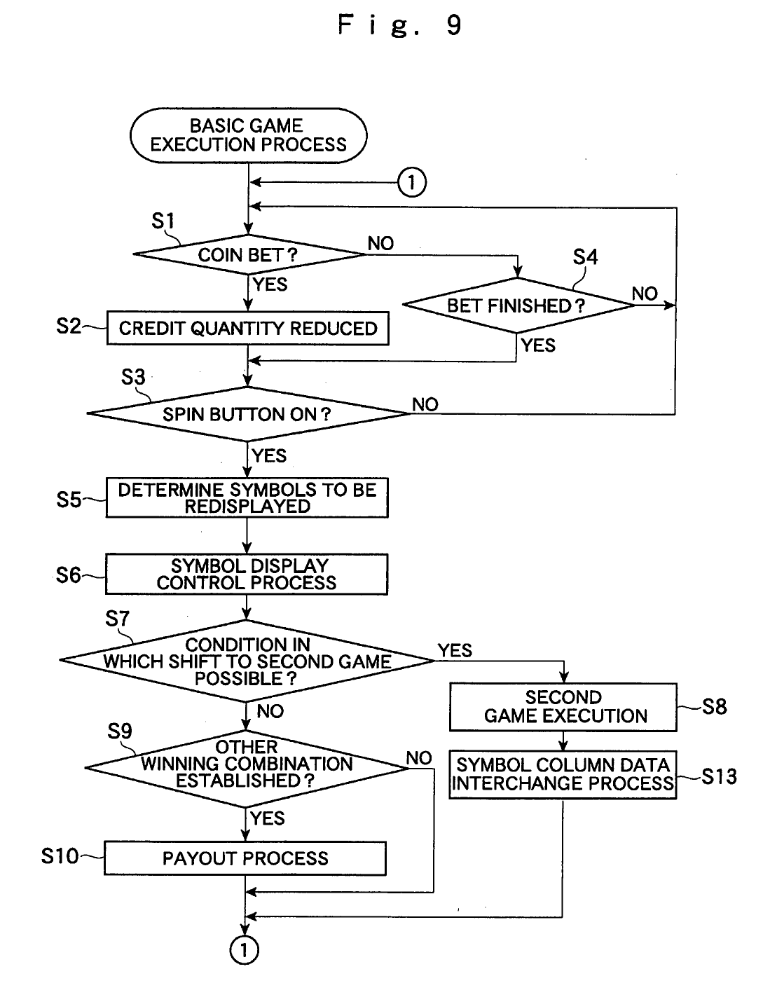

FIG. 9 is a flowchart showing processing details of a basic game program executed by a gaming machine in a second embodiment of the invention;

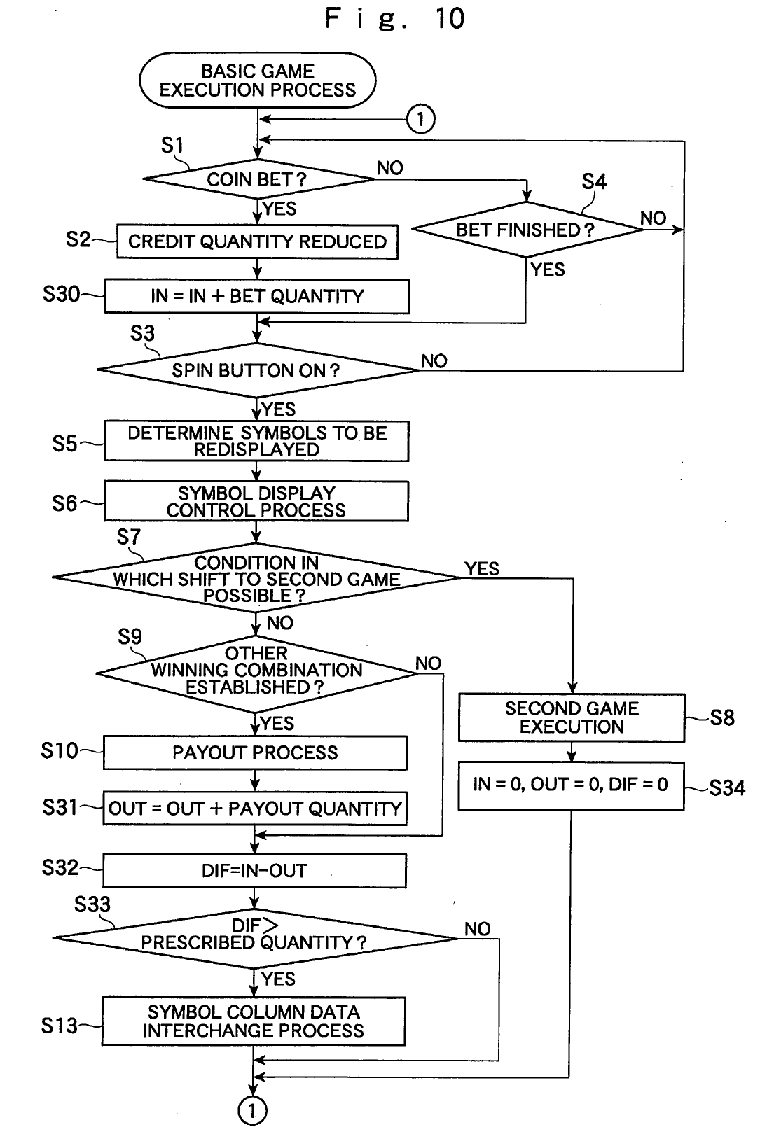

FIG. 10 is a flowchart showing processing details of a basic game program executed by a gaming machine in a third embodiment of the invention;

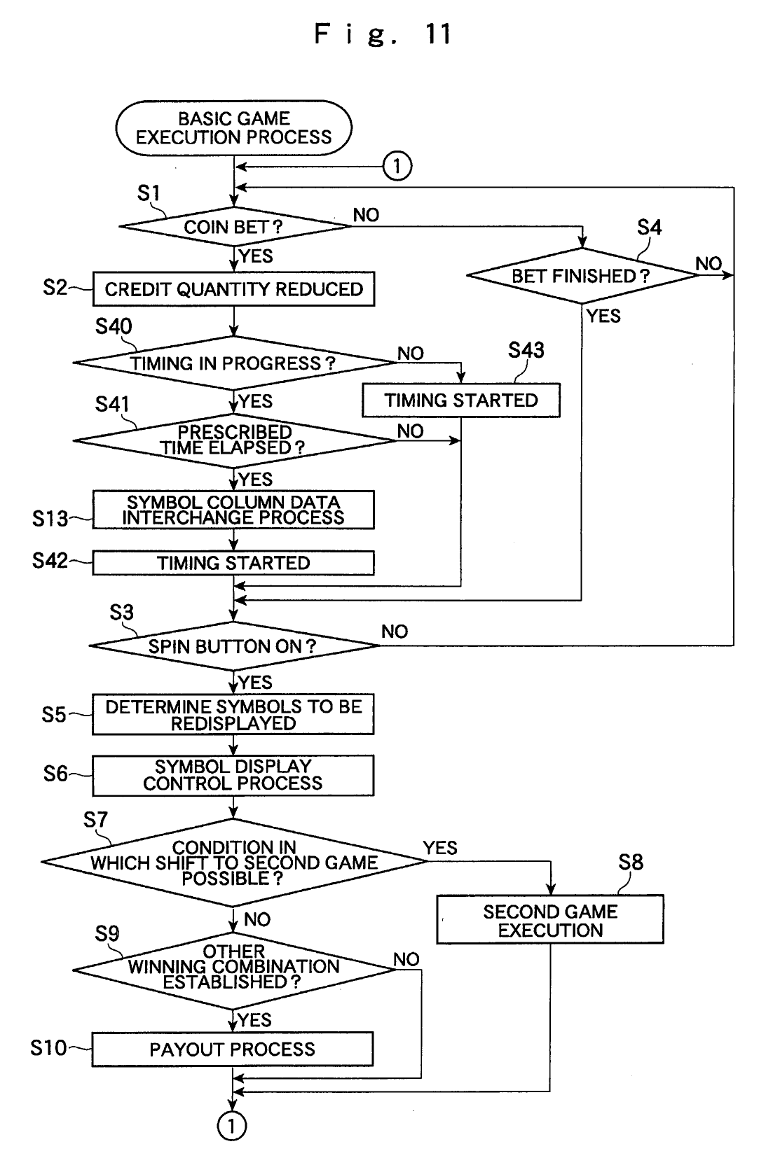

FIG. 11 is a flowchart showing processing details of a basic game program executed by a gaming machine in a fourth embodiment of the invention; and

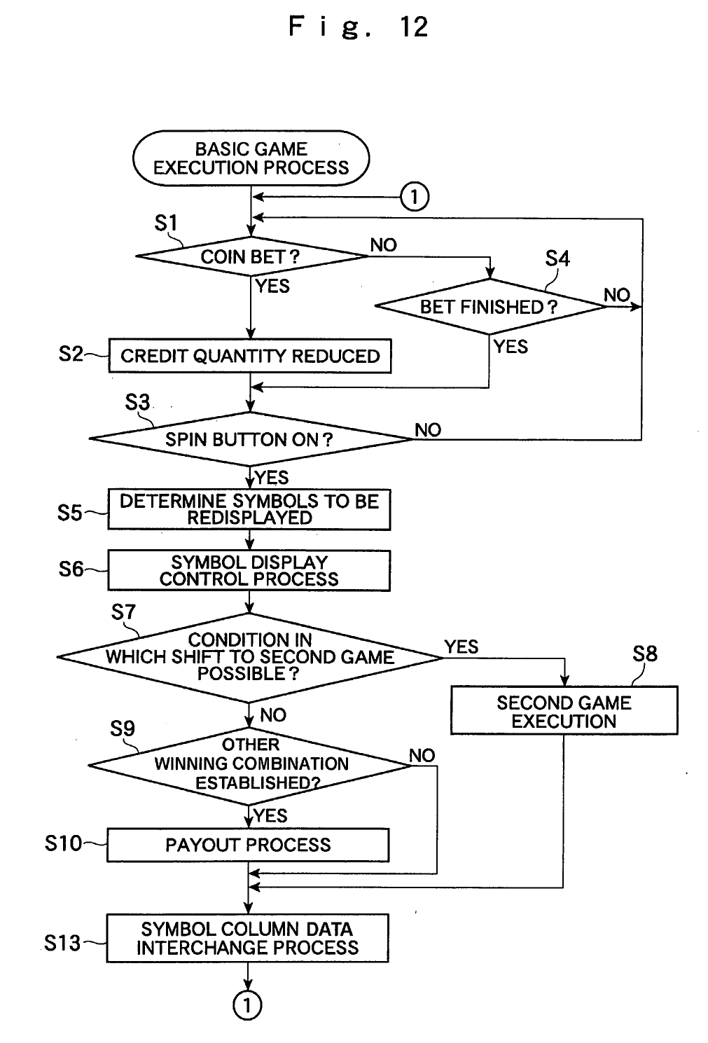

FIG. 12 is a flowchart showing processing details of a basic game program executed by a gaming machine in a fifth embodiment of the invention.

### DESCRIPTION OF THE PREFERRED EMBODIMENTS

Hereafter, a description will be given of a gaming machine of the invention, based on concrete first to fifth embodiments in which it is embodied using a slot machine, with reference to the drawings. The slot machine in the first to fifth embodiments is a so-called video slot machine, having an image display device such as a liquid crystal display, which carries out a game displaying images of various kinds of symbol on the relevant image display device.

Also, the video slot machine in the first to fifth embodiments displays nine symbols in a three row by three column matrix formation on the image display device, and carries out a scroll display of each symbol image in accordance with an instruction from a player. Then, when a predetermined time elapses, the video slot machine stops the relevant scroll display, and pays the player a game medium such as a coin in accordance with a combination of redisplayed symbols. Each symbol image displayed on the image display device is one symbol image from among a symbol column in which a certain order is fixed for a plurality of the symbol images configured of a plurality of kinds of symbol image. Then, in the heretofore described scroll display, each symbol image configuring the symbol column is sequentially displayed in accordance with the order of each symbol column. Hereafter, in each embodiment, the “symbol image” will be referred to simply as the “symbol”.

The gaming machine of the invention to be described based on the heretofore mentioned slot machine shown in the first to fifth embodiments has a feature of changing a correlation between a display position of the nine symbols displayed in the three row by three column matrix formation, and the symbol columns. That is, a symbol column displayed in a certain display position, and a symbol column displayed in another display position, are interchanged.

Although a condition which is a trigger for changing the correlation between each display position of the symbols and each symbol column can be fixed as appropriate, specific examples will be described hereafter in the first to fifth embodiments.

### First Embodiment

A description will be given of a configuration of a slot machine according to a first embodiment of the invention, referring to FIG. 1. FIG. 1 is a perspective view showing an external view of a slot machine 10 according to the first embodiment. In the slot machine 10, an execution of one game (a unit game) being possible on a condition of a game start operation by a player being accepted, a coin, a bill, or electronic valuable information equivalent to them, is used as a game medium inserted into the slot machine 10 in order to execute the unit game. However, the game medium not being limited to the above, it is also acceptable to use, for example, a medal, a token, electronic money or a ticket. Herein, as the ticket, there is, for example, a bar-coded ticket, such as to be described hereafter, and the like.

As shown in FIG. 1, the slot machine 10 includes a cabinet 11, a top box 12 disposed on top of the cabinet 11, and a main door 13 provided on a front of the cabinet 11. A lower image display panel 14, which is a liquid crystal image display device, is provided in a front of the main door 13. Although a description will be given hereafter of detailed display details of the lower image display panel 14, nine symbols being displayed on the lower image display panel 14, in the event that the player carries out an instruction for a redisplay, each of the nine symbols is scroll displayed, exactly as though a reel on which a plurality of kinds of symbol are depicted were rotating. Then, the scrolling stops when a predetermined time elapses, and a kind of symbol differing from that before the scrolling or, in a certain case, the same kind of symbol as that before the scrolling, is newly displayed. Hereafter, the scrolling of the symbol displayed on the lower image display panel 14, and the symbol subsequently being newly displayed, will be referred as the redisplay. When the redisplay is carried out, in the event that a combination of symbols displayed along a predetermined payout line matches a winning combination, the slot machine 10 pays the player a number of coins corresponding to a dividend of the winning combination. A touch sensitive screen 15 being provided on a screen surface of the lower image display panel 14, the player can input various kinds of instruction into the slot machine 10 by touching the touch sensitive screen 15.

A control panel 16 is provided below the lower image display panel 14. A CASH OUT button 17, a CHANGE button 18, a 1-BET button 19, a SPIN button 20 and a MAX-BET button 21 are provided on the control panel 16. The CASH OUT button 17 is a button for inputting an instruction to pay credited coins back to the player. The CHANGE button 18 is a button used when requesting a changing of money from an attendant of a game establishment in which the slot machine 10 is installed. The 1-BET button 19 is a button for inputting an instruction to bet one coin, from among the credited coins, on the game. The SPIN button 20 is a button for inputting an instruction to cause the redisplay of the symbol. The MAX-BET button 21 is a button for inputting an instruction to bet a maximum number (for example, three) of coins, from among the credited coins, which can be bet on one game.

A coin acceptor 22 is provided to the right of the heretofore described various buttons. By this means, in the slot machine 10, as a method of betting the coin, as well as pressing the heretofore described 1-BET button 19 or MAX-BET button 21, there is a method which involves inserting the coin via the coin acceptor 22. A bill validator 23, as well as distinguishing whether or not a bill is legitimate, accepts a legitimate bill into the cabinet 11. It is also acceptable that the bill validator 23 is configured in such a way as to be able to read a bar-coded ticket 32a, to be described hereafter. A belly glass 24, on which is depicted a character or the like of the slot machine 10, is provided below the control panel 16. A coin payout opening 25 for paying the coins to the player is provided below the belly glass 24. Also, the coins paid out from the coin payout opening 25 are collected in a coin tray 26 provided in a lowermost front of the main door 13.

An upper image display panel 30 is provided on a front of the top box 12 provided on a top of the cabinet 11. The upper image display panel 30 includes a liquid crystal panel on which is displayed, for example, an effect image, or an image representing an introduction of game details or an explanation of game rules. Also, a speaker 31 for emitting a sound is provided on the top box 12. A ticket printer 32, a keypad 33, a data indicator 34 and a card reader 35 are provided below the upper image display panel 30. The ticket printer 32 prints a bar code, into which are encoded data such as a credit quantity, a date and time, and an identification number of the slot machine 10, onto a ticket, and outputs the ticket as the bar-coded ticket 32a. The player can also play on another slot machine using the bar-coded ticket 32a. Also, it is also possible to change the bar-coded ticket 32a for a bill or the like with a cashier etc. at the game establishment. The keypad 33 is for inputting instructions or data relating to an issuing or the like of the heretofore described bar-coded ticket 32a. The data indicator 34, being configured of a fluorescent display or the like, displays, for example, data input by the player via the keypad 33, or data read by the card reader 35. The card reader 35 reads data from a memory embedded in a smart card, and writes the data onto the relevant memory. The smart card is a card which the player possesses, on which are stored, for example, data for identifying the player and data relating to a history of a game which the player has played.

Next, a description will be given of the previously mentioned display details of the lower image display panel 14, referring to FIG. 2. FIG. 2 shows a screen of the lower image display panel 14. As shown in the figure, a payout quantity display area PY and a BET quantity display area BT are positioned in a top left of the screen of the lower image display panel 14. A number of coins to be paid to the player is displayed in the payout quantity display area PY when one game has finished. A number of coins which the player has bet on one game is displayed in the BET quantity display area BT. A credit quantity display area CR is positioned in a top right of the screen of the lower image display panel 14. A number of credited coins is displayed in the credit quantity display area CR.

Nine display areas A to I for displaying symbols are positioned in an approximate center of the screen of the lower image display panel 14. Also, the display areas A to I, as shown in FIG. 2, are disposed in a three row by three column matrix formation. One of nine symbol column data SL1 to SL9, shown in FIG. 3 and FIG. 4, corresponding to the display areas A to I, one of twenty-two symbols indicated by the corresponding symbol column data is displayed inside each display area. Each of the symbol column data, as shown in FIG. 3 and FIG. 4, is configured of 10 kinds of symbol: “JACKPOT”, “PLUM”, “ORANGE”, “LOBSTER”, “SEVEN”, “CHERRY”, “BELL”, “STRAWBERRY”, “APPLE” and “CRAB”. Then, 22 of these 10 kinds of symbol are arbitrarily aligned, and a unique code number is affixed to each symbol. Then, when the player presses the SPIN button 20, the symbols displayed inside each display area are scroll displayed in accordance with an order of the code numbers.

In FIG. 2, eight payout lines L1 to L8 are fixed for the display areas A to I. The payout line L1 is a line which passes through the display areas A, B and C. The payout line L2 is a line which passes through the display areas D, E and F. The payout line L3 is a line which passes through the display areas G, H and I. The payout line L4 is a line which passes through the display areas A, D and G. The payout line L5 is a line which passes through the display areas B, E and H. The payout line L6 is a line which passes through the display areas C, F and I. The payout line L7 is a line which passes through the display areas G, E and C. The payout line L8 is a line which passes through the display areas A, E and I.

Also, a number of payout lines, among the eight payout lines in each of the heretofore described disposition aspects, considered to be activated in response to the number of coins bet on one game differs. That is, in the event that the number of coins bet on one game is one, only the payout lines L1, L2 and L3 shown in FIG. 2 are considered to be activated. Also, in the event that the number of coins bet on one game is two, the payout lines L1 to L6 are considered to be activated, while in the event that the number of coins bet on one game is three, all the payout lines L1 to L8 are considered to be activated.

Next, a description will be given of a configuration of a control circuit of the slot machine 10, referring to FIG. 5. FIG. 5 is a block diagram showing the configuration of the control circuit of the slot machine 10. As shown in the figure, the control circuit is configured of components such as a mother board 40, a gaming board 50, a main body PCB (Printed Circuit Board) 60, a door PCB 80, and various switches and sensors. The gaming board 50 includes a CPU 51, a boot ROM 52 and an ROM 53, which are mutually connected via an internal bus, a card slot 54S compatible with a memory card 54, and an IC socket 55S compatible with a GAL (Generic Array Logic) 55.

The CPU 51, boot ROM 52 and ROM 53, which are mutually connected via the internal bus, are connected to the mother board 40 via a PCI bus. The PCI bus, as well as carrying out a signal transmission between the mother board 40 and the gaming board 50, carries out a supply of power from the mother board 40 to the gaming board 50. A preliminary authentication program, and a program (a boot code) and the like for the CPU 51 to boot up the preliminary authentication program, are stored in the boot ROM 52. Country identification information and an authentication program are stored in the ROM 53. The authentication program is a program (an alteration checking program) for authenticating a game program and a game system program. The authentication program is a program for carrying out a confirmation and certification that the game program and game system program have not been altered. That is, the authentication program is described in accordance with a procedure which carries out the authentication of the game program and game system program. The preliminary authentication program is a program for authenticating the heretofore described authentication program. The preliminary authentication program is described in accordance with a procedure which carries out a certification that the authentication program which is a subject of an authentication process has not been altered, that is, the authentication of the authentication program.

The memory card 54 stores the game program, the game system program, and various kinds of data for carrying out a process relating to the game. A first program for executing a basic game, a second program for executing a second game, and the like are included in the game program written onto the memory card 54 as programs related to an implementation of the game. The second game is a game, among a prescribed number of games, in which, compared to the basic game, a high dividend is granted to the player. Also, a redisplayed symbol determination process program is included in the game program. The redisplayed symbol determination process program is a program for determining the redisplayed symbols. Symbol weighing data corresponding to a plurality of kinds of payout ratio (for example, 80%, 84% and 88%) are included in the redisplayed symbol determination process program. The symbol weighing data are data which indicate a correlation between a unique code number appended to each of the plurality of symbols which may be displayed in each of the display areas A to I, and one or a plurality of random numbers belonging to a prescribed range of numbers (0 to 256). The payout ratio being fixed based on payout ratio setting data transmitted from the GAL 55, the redisplayed symbol determination process is carried out based on symbol weighing data corresponding to this payout ratio. Also, in addition to image data and sound data transmitted during the game, data fixing a plurality of versions of winning combination, and a dividend corresponding to each winning combination, are included in the game program. A winning combination which results in the heretofore described second game being started is included among the winning combinations.

Furthermore, the kind of data shown in FIG. 6 relating to the payout lines are also included in the game program. In FIG. 6, a “display area” column shows which display areas, among the display areas A to I shown in FIG. 2, the payout lines L1 to L8 pass through. Also, columns “one coin”, “two coins” and “three coins” show payout lines considered to be activated in accordance with the number of coins which the player has bet on one game. That is, they show that, in each column, payout lines marked with a “o” are considered to be activated payout lines. As the relationship between the number of coins bet on one game, and the payout lines considered to be activated, has already been described referring to FIG. 2, a detailed description will be omitted here.

The card slot 54S, being configured in such a way that the memory card 54 can be inserted into and removed from it, is connected to the mother board 40 via an IDE bus. Consequently, by removing the memory card 54 from the card slot 54S, writing another game program and game system program onto the memory card 54, and inserting the memory card 54 into the card slot 54S, it is possible to change a type and details of the game carried out on the slot machine 10. The GAL 55 including a plurality of input ports and output ports, when data are input into the input ports, data corresponding to the data are output from the output ports. The data output from the output ports are the heretofore described payout ratio setting data. Also, the IC socket 55S, being configured in such a way that the GAL 55 can be attached to and removed from it, is connected to the mother board 40 via the PCI bus. Consequently, by removing the GAL 55 from the IC socket 55S, rewriting the program stored in the GAL 55, and attaching the GAL 55 to the IC socket 55S, it is possible to change the payout ratio setting data transmitted from the GAL 55.

The mother board 40 includes a main CPU 41 (a processor), an ROM 42, an RAM 43 and a communication interface 44. The main CPU 41 includes a function as the processor which controls a whole of the slot machine 10. In particular, the main CPU 41 carries but a control causing the nine symbols displayed on the lower image display panel 14 to scroll inside the display areas, when the player has bet a credit and pressed the SPIN button 20, a control determining, before stopping the scrolling, symbols to be redisplayed, and a control stopping the scrolling in such a way as to actually stop the determined symbols in the display areas of the lower image display panel 14. Also, the main CPU 41, in the event that a combination of symbols redisplayed along a payout line is a specific combination, shifts to a process for executing the previously described second game. Furthermore, the main CPU 41, having a built-in timer, can time a given time, as necessary, using the timer.

A program such as a BIOS (Basic Input/Output System) executed by the main CPU 41 being stored in the ROM 42, permanently used data are also stored. Also, when the BIOS stored in the ROM 42 is executed by the main CPU 41, as well as a process of initializing each peripheral device being carried out, a process of reading the game program, the game system program and the various data, including the symbol column data shown in FIG. 3 and FIG. 4, stored in the memory card 54 via the gaming board 50 is started, and they are moved to the RAM 43 or the like.

Also, the various data and programs used when the main CPU 41 carries out the processes are stored in the RAM 43. For example, FIG. 7 visually represents details of a storage area secured in the RAM 43 for storing the correlation between the display areas A to I shown in FIG. 2, and the symbol column data SL1 to SL9 shown in FIG. 3 and FIG. 4. In the figure, data indicating which of the symbol column data SL1 to SL9 they are are stored in a “symbol column data” column. The main CPU 41, referring to the details of FIG. 7, judges the symbol columns to be displayed in the display areas A to I. Herein, in the embodiment, the display areas A to Iand the symbol column data SL1 to SL9 are taken to correspond one to one. Also, it is shown in FIG. 7 that, as an initial value, the symbol column data SL1 correspond to the display area A, the symbol column data SL2 correspond to the display area B, the symbol column data SL3 correspond to the display area C, the symbol column data SL4 correspond to the display area D, the symbol column data SL5 correspond to the display area E, the symbol column data SL6 correspond to the display area F, the symbol column data SL7 correspond to the display area G, the symbol column data SL8 correspond to the display area H, and the symbol column data SL9 correspond to the display area I.

Consequently, the RAM 43 corresponds to a memory which stores the plurality of symbol column data, fixing the order of the plurality of symbols composed of the plurality of kinds of symbol, and the correlation data, indicating the correlation between each of the relevant plurality of symbol column data and each of the previously described plurality of display positions.

Also, the RAM 43, apart from this, also includes an area which stores a value of a variable CNT for storing a number of games which the player has executed, the number of coins bet by the player, the number of credited coins, and the like. The communication interface 44 is for carrying out a communication with a host computer provided in the game establishment, via a communication line.

Also, a main body PCB 60 and a door PCB 80 are each connected to the mother board 40 via a USB (Universal Serial Bus). Furthermore, a power unit 45 is connected to the mother board 40. When the power is supplied to the mother board 40 from the power unit 45, as well as the main CPU 41 of the mother board 40 booting up, the power is supplied to the gaming board 50 via the PCI bus, and the CPU 51 boots up.

An instrument or a device, which generates an input signal to be input into the main CPU 41, and an instrument or a device, an operation of which is controlled by a control signal transmitted from the main CPU 41, are connected to the main body PCB 60 and the door PCB 80. The main CPU 41, based on the input signal input into the main CPU 41, by executing the game program and game system program stored in the RAM 43, carries out a calculation process, stores a result thereof in the RAM 43, and carries out a process transmitting the control signal to each instrument or device as a control process with respect to each instrument or device.

A hopper 61, a coin detector 62, a graphic board 63, the speaker 31, the touch sensitive screen 15, the bill validator 23, the ticket printer 32, a KEY switch 33S, the data indicator 34 and the card reader 35 are connected to the main body PCB 60. The hopper 61, being installed in the cabinet 11, based on the control signal transmitted from the main CPU 41, pays a prescribed number of coins into the coin tray 26 through the coin payout opening 25. The coin detector 62, being provided inside the coin payout opening 25, when detecting that the prescribed number of coins has been paid out through the coin payout opening 25, transmits an input signal to the main CPU 41. The graphic board 63, based on the control signal transmitted from the main CPU 41, controls an image display on the upper image display panel 30 and the lower image display panel 14. The credit quantity stored in the RAM 43 is displayed in the credit quantity display area CR (refer to FIG. 2) of the lower image display panel 14. Also, the coin payout quantity, and the number of coins which the player has bet, are displayed respectively in the payout quantity display area PY and the BET quantity display area BT (refer to FIG. 2) of the lower image display panel 14. Also, the graphic board 63 includes a VDP (Video Display Processor), which generates image data based on the control signal transmitted from the main CPU 41, and a video RAM or the like, which temporarily stores the image data generated by the VDP.

The bill validator 23 reads an image on a bill, and accepts a legitimate bill into the cabinet 11. Also, the bill validator 23, when accepting the legitimate bill, transmits an input signal to the main CPU 41 based on a value of the bill. The main CPU 41 stores a credit quantity corresponding to the value of the bill transmitted via the input signal in the RAM 43. The ticket printer 32, based on the control signal transmitted from the main CPU 41, prints the bar code into which are encoded the data on the identification number etc. of the slot machine 10, the current date and time, and the credit quantity stored in the RAM 43, on a ticket, and outputs the ticket as the bar-coded ticket 32a. The KEY switch 33S, being provided on the keypad 33, when the keypad 33 is operated by the player, transmits an input signal to the main CPU 41. The data indicator 34, based on the control signal transmitted from the main CPU 41, displays the data read by the card reader 35 and the data input by the player via the keypad 33. The card reader 35 reads the data from the smart card and transmits them to the main CPU 41 and, based on the control signal from the main CPU 41, carries out the writing of the data onto the smart card.

The various kinds of switch provided on the control panel 16, a reverter 22S, a coin counter 22C and a cold cathode tube 81 are connected to the door PCB 80. As previously described, a CASH OUT switch 17S corresponding to the CASH OUT button 17, a CHANGE switch 18S corresponding to the CHANGE button 18, a 1-BET switch 19S corresponding to the 1-BET button 19, a SPIN switch 20S corresponding to the SPIN button 20, and a MAX-BET switch 21S corresponding to the MAX-BET button 21 are provided on the control panel 16. Each switch 17S to 21S, when the corresponding button 17 to 21 is operated by the player, transmits an input signal to the main CPU 41.

The coin counter 22C, being provided inside the coin acceptor 22, distinguishes whether or not a coin inserted into the coin acceptor 22 by the player is legitimate. Coins other than legitimate coins are ejected from the coin payout opening 25. Also, the coin counter 22C, when detecting a legitimate coin, transmits an input signal to the main CPU 41. The reverter 22S, operating based on the control signal transmitted from the main CPU 41, sorts coins recognized as the legitimate coins by the coin counter 22C into a cash box (not shown) disposed in the slot machine 10, or into the hopper 61. That is, in the event that the hopper 61 is filled with coins, the reverter 22S sorts the legitimate coins into the cash box. Meanwhile, in the event that the hopper 61 is not filled with coins, the reverter 22S sorts the legitimate coins into the hopper 61. The cold cathode tube 81, functioning as a backlight disposed on a back of each of the lower image display panel 14 and the upper image display panel 30, comes on based on the control signal transmitted from the main CPU 41.

The slot machine 10 having the above configuration, firstly, when the power is turned on in the power unit 45 shown in FIG. 5, boots up the mother board 40 and gaming board 50. When the mother board 40 and gaming board 50 are booted up, processes distinct to each are carried out in parallel. That is, in the gaming board 50, the CPU 51 carries out a reading of the preliminary authentication program stored in the boot ROM 52 and, in accordance with the preliminary authentication program read, carries out the preliminary authentication confirming and certifying in advance that no alteration of the authentication program has been carried out, before it is downloaded onto the mother board 40.

Meanwhile, in the mother board 40, the main CPU 41 executes the BIOS stored in the ROM 42, and expands compressed data embedded in the BIOS to the RAM 43. Then, the main CPU 41 executes the BIOS expanded to the RAM 43, and carries out a diagnosis and initialization of each kind of peripheral device. Subsequently, the main CPU 41 carries out a reading of the authentication program stored in the ROM 53, via the PCI bus. Furthermore, the main CPU 41 carries out a process storing the authentication program read in the RAM 43. Next, the main CPU 41 accesses the memory card 54 attached to the card slot 54S via an IDE bus. Then, the main CPU 41 carries out a reading of the game program and the game system program stored in the memory card 54. Next, the main CPU 41, in accordance with the authentication program stored in the RAM 43, carries out an authentication confirming and certifying that no alteration of the game program and the game system program read has been carried out.

In the event that the authentication process finishes normally, the main CPU 41 stores the authenticated game program and game system program, including the first game program, in the RAM 43. Then, the main CPU 41 accesses the GAL 55 attached to the IC socket 55S via the PCI bus, reads the payout ratio setting data from the GAL 55, and stores them in the RAM 43. Also, the main CPU 41, as well as carrying out a reading of the country identification information stored in the ROM 53 of the gaming board 50, via the PCI bus, stores the country identification information read in the RAM 43. After carrying out these kinds of process, the main CPU 41, by sequentially reading and executing the basic game program (the first program) stored in the RAM 43, implements the basic game. By this means, the main CPU 41 functions as the processor.

Hereafter, a description will be given of details of an execution process of the basic game, referring to the flowchart shown in FIG. 8. In an initial condition, the symbol column data SL1 to SL9 corresponding, as shown in FIG. 7, to the display areas A to I on the screen of the lower image display panel 14 shown in FIG. 2, it is taken that one random symbol, from among each symbol column data, is displayed in each display area A to I. Firstly, the main CPU 41 judges whether or not a coin has been bet (step S1). In this process, the main CPU 41 judges whether or not it has received an input signal transmitted from the 1-BET switch 19S when the 1-BET button 19 is pressed, or an input signal transmitted from the MAX-BET switch 21S when the MAX-BET button 21 is pressed. In step S1, if it judges that the coin has been bet, a step S1 judgment result being “Yes”, the main CPU 41 subtracts the number of coins which the player has bet from the credit quantity stored in the RAM 43, and updates a value of the credit quantity displayed in the credit quantity display area CR shown in FIG. 2 (step S2). Also, the main CPU 41, as well as storing the number of coins bet in the RAM 43, displays it in the BET quantity display area BT shown in FIG. 2.

Next, the main CPU 41 judges whether or not the SPIN button 20 has been pressed by the player (step S3). In this process, the main CPU 41 judges based on whether or not it has received an input signal transmitted from the SPIN switch 20S when the SPIN button 20 has been pressed by the player. If it judges that the SPIN button 20 has not been pressed, a step S3 judgment result being “No”, the main CPU 41 returns to the process of step S. Also, if, in step S, the main CPU 41 judges that no coin has been bet, the step S1 judgment result being “No”, the main CPU 41 judges whether or not a coin has already been bet (step S4). If the coin has already been bet, a step S4 judgment result being “Yes”, the main CPU 41 shifts to step S3, and judges whether or not the SPIN button 20 has been pressed. Contrarily, if not even one coin has been bet, the step S4 judgment result being “No”, the main CPU 41 returns to the process of step S1.

If the player presses the SPIN button 20 in a condition in which the coin has been bet, the step S3 judgment result being “Yes”, the main CPU 41 determines symbols to be redisplayed in the display areas A to I (step S5). In this process, the main CPU 41 determines the symbols to be redisplayed in the display areas A to I by executing the redisplayed symbol determination process program, which is read from the memory card 54 and stored in the RAM 43. Next, the main CPU 41 carries out a symbol display control process, using the lower image display panel 14 (step S6). By means of this process, each symbol configuring each symbol column data SL1 to SL9 is scroll displayed, in accordance with the order of the code numbers, inside the display areas A to I on the lower image display panel 14. Then, when the predetermined time has elapsed, the main CPU 41 stops the scroll displays in such a way that the symbols determined in step S5 are displayed in the display areas.

When the scroll displays in the display areas A to I have stopped, the main CPU 41 judges whether or not a combination of symbols stop displayed along a payout line considered to be activated matches the winning combination which results in shifting to the second game (step S7). That is, the main CPU 41, first, referring to the number of coins bet stored in the RAM 43 and to the data shown in FIG. 6, considers the payout lines L1 to L3 to be activated payout lines if the number of coins bet is one, considers the payout lines L1 to L6 to be activated payout lines if the number of coins bet is two, and considers all the payout lines to be activated payout lines if the number of coins bet is three. Then, the main CPU 41, referring to the data shown in FIG. 6, compares the combinations of symbols redisplayed in the display areas through which the payout lines considered to be activated pass with the winning combination which results in shifting to the second game, and judges whether or not there is a match. Then, if a matching combination of symbols has been redisplayed, a step S7 judgment result being “Yes”, the main CPU 41 executes a second game program stored in the RAM 43 (step S8). By this means, the player can play the second game a prescribed number of times. Then, when the second game has been played the prescribed number of times, one basic game finishes, and the main CPU 41 returns to the process of step S1 and adopts a waiting condition, repeatedly carrying out the processes of step S1 and step S4 until the player bets the coin in order to start a next game.

Contrarily, in step S7, if it is judged that the combination of symbols stop displayed along the payout line considered to be activated does not match the winning combination which results in shifting to the second game, the step S7 judgment result being “No”, the main CPU 41 judges whether or not the combination of symbols stop displayed along the payout line considered to be activated matches another winning combination (step S9). If the combination of symbols stop displayed along the payout line considered to be activated matches any winning combination (except, however, the winning combination which results in the second game being started), a step S9 judgment result being “Yes”, the main CPU 41 carries out the payout of the coins, in accordance with the dividend of the relevant winning combination and the number of coins bet (step S10). That is, if the paid out coins are to be credited, the main CPU 41 adds a number of credits equivalent to a number of coins paid out to the credit quantity stored in the RAM 43. Also, if the coins are to be paid out, the main CPU 41 transmits a control signal to the hopper 61, and carries out a payout of a prescribed number of coins. At this time, the coin detector 62 counts a number of coins paid out from the hopper 61 and, when a count value reaches a specified number, transmits a payout completion signal to the main CPU 41. By this means, the main CPU 41 stops an operation of the hopper 61, and finishes the coin payout process. The coin payout process finishes.

When the main CPU 41 has finished the payout process of step S10, the main CPU41 adds “1” to the value of the variable CNT (the initial value is “0”) stored in the RAM43 (step S11). If there is no match with any winning combination in step S9, the step S9 judgment result being “No”, the main CPU 41 carries out the process of step S11, without carrying out the process of step S10. The main CPU 41, when it has finished the process of step S11, judges whether or not the value of the variable CNT has reached “1,000” (step S12). Then, if the value of the variable CNT has not reached “1,000”, a step S12 judgment result being “No”, one basic game finishes directly, and the main CPU 41 returns to the process of step S1. Contrarily, if, in step S12, the value of the variable CNT has reached “1,000”, the step S12 judgment result being “Yes”, the main CPU 41 carries out a symbol column data interchange process (step S13). That is, firstly, the main CPU 41 randomly changes the symbol column data SL1 to SL9 corresponding to the display areas A to I, in the data representing the correlation between the display areas A to I and the symbol column data SL1 to SL9 (refer to FIG. 7), stored in the RAM 43. Then, the main CPU 41 displays one symbol of the symbol column data, after changing the heretofore described correlation, in each display area A to I of the lower image display panel 14. The symbols displayed at this point are taken to be the symbols redisplayed in the previously described step S6. That is, when the symbol column data interchange process of step S13 is carried out, the display positions of the symbols redisplayed in the display areas A to I shown in FIG. 2 being randomly interchanged, it seems to the player exactly as though the display positions of the redisplayed symbols have been shuffled.

When the main CPU 41 has finished the process of step S13, it makes the value of the variable CNT “0” (step S14), returns to the process of step S1, and adopts the waiting condition, repeatedly carrying out the processes of step S1 and step S4 until the player bets the coin in order to start the next game.

As heretofore described, according to the slot machine of the embodiment, the correlation between the display areas A to I and the symbol column data SL1 to SL9 changes every time the player carries out 1,000 games. For this reason, even in the event that the payout of the high dividend does not occur even after playing the game for a long time, and the player is playing the game aimlessly, it is possible to provide the player with a visual change, and prevent him or her from becoming easily bored with the game.

### Second Embodiment

Next, a description will be given of a second embodiment of the invention. As regards the basic game details, the embodiment is the same as the first embodiment, but a trigger for changing the correlation between the display areas A to I and the symbol column data SL1 to SL9 is different from that of the first embodiment. That is, in the first embodiment, the correlation between the display areas A to I and the symbol column data SL1 to SL9 is changed when the number of times the game has been executed reaches the prescribed number of times, but in the second embodiment, it is changed in the event that, when the symbols have been redisplayed, a specific symbol combination is displayed along a payout line considered to be activated.

Hereafter, in describing the second embodiment, as the appearance of the slot machine, the details of the disposition aspects, and the configuration of the control circuit and the like, are the same as those in FIG. 1 to FIG. 7, their descriptions will be omitted. Hereafter, in the embodiment, a description will be given of a basic game execution process, which the main CPU 41 executes, referring to FIG. 9. Regarding steps in FIG. 9 which carry out the same processes as the basic game execution process shown in FIG. 8, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Then, the main CPU 41 judges, in step S3, whether or not the SPIN button 20 has been pressed by the player. If the player has not pressed the SPIN button 20 (step S3, No), the main CPU 41 returns to the process of step S1. Also, in step S1, if the coin has not been bet (step S1, No), the main CPU 41 judges, in step S4, whether or not the coin has already been bet by the player and, if no coin has yet been bet (step S4, No), returns to the process of step S1. As opposed to this, if the coin has already been bet (step S4, Yes), the main CPU 41 judges, in step S3, whether or not the SPIN button 20 has been pressed.

In step S3, if the main CPU 41 judges that the SPIN button 20 has been pressed by the player (step S3, Yes), the main CPU 41 determines symbols to be redisplayed in the display areas A to I disposed on the screen of the lower image display panel 14, by means of the process of step S5. Then, the main CPU 41, in step S6, carries out the symbol display control process using the lower image display panel 14 and, after scroll displaying the symbols displayed inside the display areas A to I, stops the scroll display in such a way as to redisplay the symbols determined in step S5. When the symbols have been redisplayed in all the display areas, the main CPU 41 judges, in step S7, whether or not a combination of symbols matching the winning combination which results in shifting to the second game has been displayed along a payout line considered to be activated. If the matching combination of symbols has been displayed (step S7, Yes), the main CPU 41 executes the second game in S8.

When the second game finishes, the main CPU 41, in the same way as in step S13 of FIG. 8 described in the first embodiment, carries out the symbol column data interchange process. That is, the main CPU 41 randomly changes the symbol column data SL1 to SL9 corresponding to the display areas A to I, in the data representing the correlation between the display areas A to I and the symbol column data SL1 to SL9 (refer to FIG. 7), stored in the RAM 43. Then, the main CPU 41 displays one symbol of the symbol column data, after changing the heretofore described correlation, in each display area A to I of the lower image display panel 14. When the main CPU 41 has finished the process of step S13, it returns to the process of step S1, and adopts the waiting condition, repeatedly carrying out the processes of step S1 and step S4 until the player bets the coin in order to start the next game.

Also, in step S7, if the combination of symbols matching the winning combination which results in shifting to the second game has not been displayed along the payout line considered to be activated (step S7, No), the main CPU 41, shifting to step S9, judges whether or not the combinations of symbols stop displayed along the payout lines considered to be activated match another winning combination. Then, if there is a match with any winning combination (step S9, Yes), the main CPU 41, after, in step S10, paying out the coins in accordance with the dividend of the relevant winning combination and the number of coins bet, returns to step S1. Also, in step S9, if there is no match with any winning combination (step S9, No), the main CPU 41 returns directly to the process of step S1.

In the slot machine of the heretofore described embodiment, in the event that the combination of symbols, among the nine symbols redisplayed on the lower image display panel 14, redisplayed along the payout line considered to be activated matches the winning combination which results in the second game being started, the symbol columns are interchanged among the plurality of display positions. For this reason, the winning combination which results in the second game being started does not only have a role as a winning combination which is a trigger for the second game, which carries out a paying out of a high dividend to the player, but also has a new role of determining whether or not the symbol columns are interchanged. Therefore, in comparison with heretofore known gaming machines, it is possible to cause the player to have a greater interest in the combinations of symbols redisplayed along the payout lines considered to be activated. Not only this, in the event that the combination of symbols matching the winning combination which results in the second game being started has been redisplayed along the payout line considered to be activated, as well as giving satisfaction to the player, there is also a possibility, by varying the basic game carried out after the second game has finished, of maintaining the player's desire to continue playing the game.

In the embodiment, after the second game of step S8 has finished, the main CPU 41 carries out the process of step S13, and interchanges the correlation between the plurality of display areas and the symbol column data but, not being limited to this, it is also acceptable, carrying out the process of step S13 before carrying out the process of step S8, to carry out the process relating to the second game of step S8 after interchanging the correlation between the plurality of display areas and the symbol column data. Also, it is also acceptable that the combination which is the trigger for interchanging the correlation between the plurality of display areas and the symbol column data is not the winning combination which results in the second game being started. For example, in step S9, when judging whether or not the redisplayed combinations of symbols match the other winning combinations, it is also acceptable, when it is judged that there is a match with any specific winning combination among a plurality of winning combinations, to carry out the processes of step S13. In this case, it is also acceptable that the dividend is not necessarily fixed for the heretofore described specific winning combination. That is, in the event that a combination of symbols redisplayed along the payout line considered to be activated matches the heretofore described specific winning combination, it is also acceptable to interchange the correlation between the plurality of display areas and the symbol column data, without the coins being paid out to the player.

### Third Embodiment

Next, a description will be given of a third embodiment of the invention. As regards the basic game details, the embodiment is the same as the first and second embodiments, but the correlation between the display areas A to I and the symbol column data SL1 to SL9 is changed based on an accumulative value of the coins which the player has inserted, and an accumulative value of the coins which the slot machine 10 has paid out. Hereafter, in describing the third embodiment, as the appearance of the slot machine, the details of the disposition aspects, and the configuration of the control circuit and the like, are the same as those in FIG. 1 to FIG. 7, their descriptions will be omitted. However, a storage area is set in the RAM 43 of the control circuit shown in FIG. 5 for storing values of variables, those being a variable IN for counting the number of coins which the player has inserted into the slot machine 10, a variable OUT for counting the number of coins which the slot machine 10 has paid to the player, and a variable DIF for storing a difference between a value of the variable IN and a value of the variable OUT.

Hereafter, in the embodiment, a description will be given of a basic game execution process, which the main CPU 41 executes, referring to FIG. 10. Regarding steps in FIG. 10 which carry out the same processes as the basic game execution process shown in FIG. 8, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Also, the main CPU 41 adds the number of coins which the player has bet to the value of the variable IN stored in the RAM 43 (step S30). Subsequently, the main CPU 41 judges, in step S3, whether or not the SPIN button 20 has been pressed by the player. If the player has not pressed the SPIN button 20 (step S3, No), the main CPU 41 returns to the process of step S1. Also, in step S1, if the coin has not been bet (step S1, No), the main CPU 41 judges, in step S4, whether or not the coin has already been bet by the player and, if no coin has yet been bet (step S4, No), returns to the process of step S1. As opposed to this, if the coin has already been bet (step S4, Yes), the main CPU 41 judges, in step S3, whether or not the SPIN button 20 has been pressed.

In step S3, if the main CPU 41 judges that the SPIN button 20 has been pressed by the player (step S3, Yes), the main CPU 41 determines symbols to be redisplayed in the display areas A to I shown in FIG. 2, by means of the process of step S5. Then, the main CPU 41, in step S6, carries out the symbol display control process using the lower image display panel 14 and, after scroll displaying the symbols displayed inside the display areas A to I, stops the scroll display in such a way as to redisplay the symbols determined in step S5. When the symbols have been redisplayed in all the display areas, the main CPU 41 judges, in step S7, whether or not a combination of symbols matching the winning combination which results in shifting to the second game has been displayed along a payout line considered to be activated. If the matching combination of symbols has been displayed (step S7, Yes), the main CPU 41 executes the second game in S8.

Then, when the second game finishes, the main CPU 41 makes the values of the variable IN, the variable OUT and the variable DIF, stored in the RAM 43, “0” (step S34). Then, the main CPU 41 returns to the process of step S1, and adopts the waiting condition, repeatedly carrying out the processes of step S1 and step S4 until the player bets the coin in order to start the next game. As opposed to this, in step S7, if the combination of symbols matching the winning combination which results in shifting to the second game has not been displayed along the payout line considered to be activated (step S7, No), the main CPU 41, shifting to step S9, judges whether or not the combinations of symbols stop displayed along the payout lines considered to be activated match another winning combination.

If there is a match with any winning combination (step S9, Yes), the main CPU 41, in step S10, pays out the coins in accordance with the dividend of the relevant winning combination and the number of coins bet. Then, the main CPU 41 adds the number of coins paid out in step S10 to the value of the variable OUT stored in the RAM 43 (step S31), subtracts the value of the variable OUT from the value of the variable IN, and makes a result thereof the value of the variable DIF (step S32). In step S9, if there is no match with any winning combination, a step S9 judgment result being “No”, the main CPU 41 carries out the process of step S32, without carrying out the processes of step S10 and step S31.

The main CPU 41, when it has finished the process of step S32, judges whether or not the value of the variable DIF has exceeded a predetermined value (for example, 100) (step S33). If the value of the variable DIF has not exceeded 100, a step S33 judgment result being “No”, the main CPU 41 returns to the process of step S1, and adopts the waiting condition, repeatedly carrying out the processes of step S1 and step S4 until the player bets the coin in order to start the next game. Contrarily, if the value of the variable DIF has exceeded 100, the step S33 judgment result being “Yes”, the main CPU 41 carries out the symbol column data interchange process, in the same way as in step S13 of FIG. 8, described in the first embodiment. That is, the main CPU 41 randomly changes the symbol column data SL1 to SL9 corresponding to the display areas A to I, in the data representing the correlation between the display areas A to I and the symbol column data SL1 to SL9 (refer to FIG. 7), stored in the RAM 43. Then, the main CPU 41 displays one symbol of the symbol column data, after changing the heretofore described correlation, in each display area A to I of the lower image display panel 14. When the main CPU 41 has finished the process of step S13, it returns to the process of step S1, and adopts the waiting condition, repeatedly carrying out the processes of step S1 and step S4 until the player bets the coin in order to start the next game.

In the slot machine of the heretofore described embodiment, in the event that the number of coins which the player has inserted into the slot machine 10 is more than 100 greater than the number of coins which the slot machine 10 has paid out, the symbol columns are interchanged among the plurality of display positions. For this reason, in the event that games in which a dividend is not paid out, or only a small dividend is paid out, continue, by the symbol columns being interchanged among the plurality of display positions, there is a possibility of being able to prevent the player's interest in the game from waning.

### Fourth Embodiment

Next, a description will be given of a fourth embodiment of the invention. As regards the basic game details, the embodiment is the same as the first to third embodiments, but the correlation between the display areas A to I and the symbol column data SL1 to SL9 is changed every time a predetermined time elapses. Hereafter, in describing the fourth embodiment, as the appearance of the slot machine, the configuration of the control circuit, and the like are the same as those in FIG. 1 to FIG. 7, their descriptions will be omitted. Hereafter, in the embodiment, a description will be given of a basic game execution process, which the main CPU 41 executes, referring to FIG. 11. However, regarding steps in FIG. 11 which carry out the same processes as the basic game execution process shown in FIG. 8, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Then, the main CPU 41 judges whether or not a time measurement is being carried out by a timer built-in to the main CPU 41 (step S40). If the time measurement is being carried out by the timer, a step S40 judgment result being “Yes”, the main CPU 41 judges whether or not a time measured by the timer has exceeded the predetermined time (taken here to be 30 minutes) (step S41). If the time measured by the timer has exceeded 30 minutes, a step S41 judgment result being “Yes”, the main CPU 41, in the same way as in step S13 of FIG. 8 described in the first embodiment, carries out the symbol column data interchange process. That is, the main CPU 41 randomly changes the symbol column data SL1 to SL9 corresponding to the display areas A to I, in the data representing the correlation between the display areas A to Iand the symbol column data SL1 to SL9 (refer to FIG. 7), stored in the RAM 43. Then, the main CPU 41 resets the measured time of the timer and, after restarting the time measurement by the timer (step S42), judges whether or not the SPIN button 20 has been pressed in step S3.

If, in step S40, the timer built-in to the main CPU 41 is not carrying out the time measurement, the judgment result being “No”, the main CPU 41 starts the time measurement by the built-in timer (step S43), and judges whether or not the SPIN button 20 has been pressed in step S3. Also, in step S41, if the time measured by the timer has not reached 30 minutes, the step S41 judgment result being “No”, the main CPU 41 judges whether or not the SPIN button 20 has been pressed in step S3, without carrying out the processes of step S13 and step S42.

If, in step S3, the player has not pressed the SPIN button 20 (step S3, No), the main CPU 41 returns to the process of step S1. Also, if, in step S1, the coin has not been bet (step S1, No), the main CPU 41 judges, in step S4, whether or not the coin has already been bet by the player and, if no coin has been bet thus far (step S4, No), the main CPU 41 returns to the process of step S1. As opposed to this, if the coin has already been bet (step S4, Yes), the main CPU 41 judges whether or not the SPIN button 20 has been pressed in step S3.

If the main CPU 41 judges, in step S3, that the SPIN button 20 has been pressed by the player (step S3, Yes), the main CPU 41, by means of the process of step S5, determines symbols to be redisplayed in the display areas A to I disposed on the screen of the lower image display panel 14. Then, the main CPU 41, in step S6, carries out the symbol display control process using the lower image display panel 14 and, after scroll displaying the symbols displayed inside the display areas A to I, stops the scroll display in such a way as to redisplay the symbols determined in step S5. When the symbols have been redisplayed in all the display areas, the main CPU 41 judges, in step S7, whether or not a combination of symbols matching the winning combination which results in shifting to the second game has been displayed along a payout line considered to be activated. If the matching combination of symbols has been displayed (step S7, Yes), the main CPU 41 executes the second game in step S8. When the second game finishes, the main CPU 41 returns to the process of step S1, and adopts the waiting condition, repeatedly carrying out the processes of step S1 and step S4 until the player bets the coin in order to start the next game.

Also, in step S7, if the combination of symbols matching the winning combination which results in shifting to the second game has not been displayed along the payout line considered to be activated (step S7, No), the main CPU 41, shifting to step S9, judges whether or not the combination of symbols stop displayed along the payout line considered to be activated match another winning combination. Then, if there is a match with any winning combination (step S9, Yes), the main CPU 41, after, in step S10, paying out the coins in accordance with the dividend of the relevant winning combination and the number of coins bet, returns to step S1. Also, in step S9, if there is no match with any winning combination (step S9, No), the main CPU 41 returns directly to the process of step S1.

In this way, in the slot machine of the embodiment, the symbol columns are interchanged among the plurality of display positions every time 30 minutes elapse. For this reason, by regularly providing the player with a freshness, it is possible to prevent him or her from becoming easily bored with the game. Also, in the embodiment, as the symbol columns are interchanged among the plurality of display positions when the prescribed time elapses, regardless of an execution condition of the game in the slot machine 10, in the event that, for example, a person on a periphery sees a condition in which the interchange of the symbol columns among the plurality of display positions occurs, when the game is not being carried out on the slot machine 10, there being a possibility of attracting the person's interest, and of the person carrying out the game on the slot machine 10, there is a possibility of achieving a customer attracting effect.

### Fifth Embodiment

Next, a description will be given of a fifth embodiment of the invention. As regards the basic game details, the embodiment is the same as the first to fourth embodiments, but the correlation between the display areas A to I and the symbol column data SL1 to SL9 is changed every time the game is carried out. Hereafter, in describing the fifth embodiment, as the appearance of the slot machine 10, the configuration of the control circuit, and the like are the same as those in FIG. 1 to FIG. 7, their descriptions will be omitted. Hereafter, in the embodiment, a description will be given of a basic game execution process, which the main CPU 41 executes, referring to FIG. 12. However, regarding steps in FIG. 12 which carry out the same processes as the basic game execution process shown in FIG. 8, the same reference numerals will be appended, and a detailed description will be omitted.

In the basic game execution process in the embodiment, if the main CPU 41 judges that the coin has been bet by the player (step S1, Yes), it subtracts the number of coins which the player has bet from the credit quantity stored in the RAM 43 (step S2). Then, the main CPU 41 judges whether or not the SPIN button 20 has been pressed by the player in step S3. If the player has not pressed the SPIN button 20 (step S3, No), the main CPU 41 returns to the process of step S1. Also, if, in step S1, the coin has not been bet (step S1, No) the main CPU 41 judges, in step S4, whether or not the coin has already been bet by the player and, if no coin has been bet thus far (step S4, No), the main CPU 41 returns to the process of step S1. As opposed to this, if the coin has already been bet (step S4, Yes), the main CPU 41 judges whether or not the SPIN button 20 has been pressed in step S3.

If the main CPU 41 judges, in step S3, that the SPIN button 20 has been pressed by the player (step S3, Yes), the main CPU 41, by means of the process of step S5, determines symbols to be redisplayed in the display areas A to I disposed on the screen of the lower image display panel 14. Then, the main CPU 41, in step S6, carries out the symbol display control process using the lower image display panel 14 and, after scroll displaying the symbols displayed inside the display areas A to I, stops the scroll display in such a way as to redisplay the symbols determined in step S5. When the symbols have been redisplayed in all the display areas, the main CPU 41 judges, in step S7, whether or not a combination of symbols matching the winning combination which results in shifting to the second game has been displayed along a payout line considered to be activated. If the matching combination of symbols has been displayed (step S7, Yes), the main CPU 41 executes the second game in step S8.

When the second game finishes, the main CPU 41, in the same way as in step S13 of FIG. 8 described in the first embodiment, carries out the symbol column data interchange process. That is, the main CPU 41 randomly changes the symbol column data SL1 to SL9 corresponding to the display areas A to I, in the data representing the correlation between the display areas A to I and the symbol column data SL1 to SL9 (refer to FIG. 7), stored in the RAM 43. Then, the main CPU 41 displays one symbol of the symbol column data, after changing the heretofore described correlation, in each display area A to I of the lower image display panel 14. When the main CPU 41 has finished the process of step S13, it returns to the process of step S1, and adopts the waiting condition, repeatedly carrying out the processes of step S1 and step S4 until the player bets the coin in order to start the next game.

Also, in step S7, if the combination of symbols matching the winning combination which results in shifting to the second game has not been displayed along the payout line considered to be activated (step S7, No), the main CPU 41, shifting to step S9, judges whether or not the combination of symbols stop displayed along the payout line considered to be activated match another winning combination. Then, if there is a match with any winning combination (step S9, Yes), the main CPU 41, in step S10, pays out the coins in accordance with the dividend of the relevant winning combination and the number of coins bet. Subsequently, the main CPU 41, carrying out the heretofore described process of step S13, randomly changes the symbol column data SL1 to SL9 corresponding to the display areas A to I. Then, the main CPU 41 displays one symbol of the symbol column data, after changing the heretofore described correlation, in each display area A to I of the lower image display panel 14. After carrying out the process of step S13, the main CPU 41 returns to the process of step S1. Also, in step S9, in the case in which there is no match with any winning combination (step S9, No) too, the main CPU 41, after carrying out the process of step S13, returns to the process of step S1.

In the slot machine of the heretofore described embodiment, the symbol columns are interchanged among the plurality of display positions every time one game is carried out. By this means, the player being able, every game, to carry out the game with a fresh feeling, as though he or she is carrying out the game on a different gaming machine, it is possible to prevent the player from becoming easily bored with the game.

In the symbol column data interchanging process of the heretofore described first to fifth embodiments, all the correlations of the symbol column data SL1 to SL9 to the display areas A to I are changed but, not being limited to this, it is also acceptable to interchange symbol column data corresponding to each one among a certain number of the display areas.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A gaming machine, in which an execution of one game is possible by a game start operation by a player being accepted, comprising:
a display on which are fixed a plurality of display positions displaying symbol images;
a memory which, as well as storing a plurality of symbol column data fixing an order of a plurality of symbol data configured of a plurality of kinds of symbol data, stores correlation data indicating a correlation between each of the plurality of symbol column data and each of the plurality of display positions; and
a processor which, as well as controlling the display, controls an implementation of a game, wherein
the processor, in accordance with an instruction from the player, referring to the symbol column data and correlation data stored in the memory, after carrying out a scroll display in the display positions of the symbol images based on symbol data configuring the corresponding symbol column data in accordance with the order indicated by the symbol column data, carries out a redisplay of the symbol images by stopping the scroll display and, as well as providing an award to the player in accordance with a combination of the redisplayed symbol images, changes the correlation between the plurality of symbol column data and the plurality of display positions in the correlation data stored in the memory.

2. The gaming machine according to claim 1, wherein
the processor counts an execution quantity of the game and, every time the counted execution quantity of the game reaches a predetermined quantity, changes the correlation between the plurality of symbol column data and the plurality of display positions in the correlation data stored in the memory.

3. The gaming machine according to claim 1, wherein
the processor, in the event that the combination of redisplayed symbols is a predetermined combination, changes the correlation between the plurality of symbol column data and the plurality of display positions in the correlation data stored in the memory.

4. The gaming machine according to claim 1, wherein
the processor counts a quantity of game media inserted by the player in order to start the game, and a quantity of the game media paid to the player as the award and, in the event that a difference between the quantity of game media inserted and the quantity of game media paid out exceeds a predetermined quantity, changes the correlation between the plurality of symbol column data and the plurality of display positions in the correlation data stored in the memory.

5. The gaming machine according to claim 1, further comprising:
a timer which measures a time, wherein
the processor, every time the timer measures a predetermined time, changes the correlation between the plurality of symbol column data and the plurality of display positions in the correlation data stored in the memory.

6. The gaming machine according to claim 1, wherein
the processor, every time the player inserts the game medium, changes the correlation between the plurality of symbol column data and the plurality of display positions in the correlation data stored in the memory.

7. A gaming machine playing method, by which an execution of one game is possible by means of a game start operation by a player being accepted, comprising:
displaying some symbol images, from among a plurality of symbol columns, corresponding one to each of a plurality of display positions fixed on a display, each configured of a plurality of symbol images configured of a plurality of kinds of symbol image, in which an order of the plurality of symbol images is fixed, in the corresponding display positions;
in accordance with an instruction from the player, after scroll displaying the symbol columns corresponding one to each of the plurality of display positions, carrying out a redisplay of the symbol image by stopping the scroll display;
providing an award to the player in accordance with a combination of the redisplayed symbol images; and
changing the correlation between the plurality of symbol column data and the plurality of display positions.

8. The gaming machine playing method according to claim 7, further comprising:
counting an execution quantity of the game; and
every time the counted execution quantity of the game reaches a predetermined quantity, changing the correlation between the plurality of display positions and the plurality of symbol columns.

9. The gaming machine playing method according to claim 7, further comprising:
in the event that the combination of redisplayed symbols is a predetermined combination, changing the correlation between the plurality of display positions and the plurality of symbol columns.

10. The gaming machine playing method according to claim 7, further comprising:
counting a quantity of game media inserted by the player in order to start the game, and a quantity of the game media paid to the player as the award; and
in the event that a difference between the quantity of game media inserted and the quantity of game media paid out exceeds a predetermined quantity, changing the correlation between the plurality of display positions and the plurality of symbol columns.

11. The gaming machine playing method according to claim 7, further comprising:
changing the correlation between the plurality of display positions and the plurality of symbol columns on every measuring of a predetermined time.

12. The gaming machine playing method according to claim 7, further comprising:
changing the correlation between the plurality of display positions and the plurality of symbol columns every time the player inserts the game medium in order to start the game.
